(19) United States
(12) Patent Application Publication
(10) Pub. No.: US 2001/0017139 A1
(43) Pub. Date: Aug. 30, 2001

(54) Apparatus for transporting filter rod sections of the tobacco processing industry

(76) Inventors: Adolf Helms, Hamburg (DE); Joachim Kreidelmeyer, Hamburg (DE); Andreas Mieszala, Hamburg (DE)

Correspondence Address: VENABLE, Post Office Box 34385, Washington, DC, 20043-9998, US

(21) Appl. No.: 09/790,977

(22) Filed: Feb. 23, 2001

(30) Foreign Application Priority Data
Feb. 24, 2000 (DE) 100 08 786.8

(51) Int. Cl. B31C 13/00; A24C 5/18

(52) U.S. Cl. 131/84.1; 493/39

(57) ABSTRACT

A mass flow of filter rod sections for assembly with plain cigarettes into filter cigarettes is advanced along a path wherein the filter rod sections move sideways between upper and lower sets of adjustable microwave modules prior to entering a variable-capacity magazine for temporary storage of filter rod sections ahead of a processing machine, such as a filter cigarette maker. The modules serve to rapidly dry a softening agent, such as triacetin, which is sprayed onto the filter material (such as filaments of cellulose acetate) of the filter rod sections. Rapid drying is desirable because this renders it possible to shorten the periods of dwell of filter rod sections in the magazine and allows for a reduction of the size of the magazine.

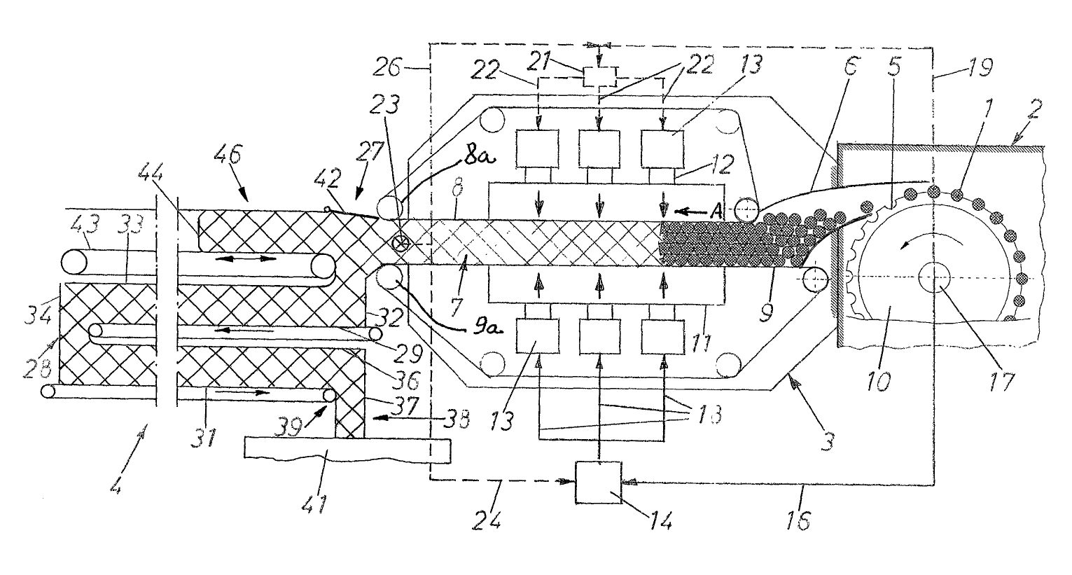

### CROSS-REFERENCE TO RELATED CASES

The present application claims the priority of the commonly owned copending German patent application Ser. No. 100 08 786.8 filed Feb. 24, 2000. The disclosure of the above-referenced German patent application, as well as that of each U.S. and foreign patent and patent application identified in the specification of the present application, is incorporated herein by reference.

### BACKGROUND OF THE INVENTION

This invention relates to improvements in methods of and in apparatus for the making and processing of rod-shaped smokers' products, and more particularly to improvements in methods of and in apparatus for making filter rod sections or filter mouthpieces of the type utilized in filter cigarettes, cigars, cigarillos and other types of smokers' products employing rod-shaped mouthpieces for tobacco smoke.

Filter mouthpieces of unit length or multiple unit length are produced in so-called filter rod making machines, e.g., in machines of the type disclosed in U.S. Pat. No. 4,412,505 granted Nov. 1, 1983 to Häusler et al. for “APPARATUS FOR APPLYING ATOMIZED LIQUID TO A RUNNING LAYER OF FILAMENTARY MATERIAL OR THE LIKE”. Such filter rod making machines can deliver filter mouthpieces of desired length into the magazines of so-called filter tipping machines designed to produce filter cigarettes or the like.

If the fibrous material of the rod-shaped filler of a mouthpiece for use in a filter cigarette consists of acetate fibers, it is customary to spray onto a running layer of stretched parallel fibers a shower of atomized softening agent (such as triacetin) which softens the thus moistened portions of the filaments and causes the softened portions to adhere to each other. Such filaments establish a maze of complex paths for the flow of tobacco smoke from the lighted end of a filter cigarette, through the tobacco-containing portion of the cigarette, through the mouthpiece and into the mouth of the smoker. It is customary to permit the atomized softener to set before the filter mouthpieces are united with plain cigarettes, and such setting is effected in a suitable magazine which is installed between the outlet of the filter rod maker and the processing machine, e.g., a filter tipping machine of the type disclosed in commonly owned U.S. Pat. No. 5,135,008 granted Aug. 4, 1992 to Oesterling et al. for “METHOD OF AND APPARATUS FOR MAKING FILTER CIGARETTES”.

In accordance with a presently known procedure, a mass flow (i.e., a multiple-layer flow) of filter rod sections is caused to advance through a variable-capacity magazine (e.g., a reservoir known as surge bin or surge chamber and acting as a “breathing” storage facility) wherein the atomized softener is allowed to set and to bond portions of neighboring filaments to each other. Diffusion of sprayed-on atomized softener in the filaments of the filter material and subsequent setting or hardening of the softener (with attendant bonding of minute portions of filaments to each other) consumes a certain interval of time.

Another variable-capacity reservoir serves as a means for compensating for recurring fluctuations between the output of the filter mouthpiece maker and a filter mouthpiece consuming or processing system. The two reservoirs take up a substantial amount of space, and this problem is aggravated in a plant wherein large numbers of production lines (each of which can include a maker of filter rod sections, a cigarette making machine, a filter tipping machine which receives plain cigarettes from the cigarette maker and filter mouthpieces from the filter rod making machine, and two magazines between each pair of filter rod making and filter tipping machines) are installed in a hall and each such production line is set up to turn out untold thousands of filter cigarettes per minute.

The filter rod sections of the mass flow advancing between a filter rod making machine and a filter tipping machine are maintained at room temperature. Such treatment, combined with the advisability of maintaining the number of superimposed layers of filter rod sections in the mass flow below a certain maximum permissible number (namely below a number which could entail deformation of filter rod sections in the lower or lowermost layers of the mass flow), contributes to the bulk of the apparatus or units which must be installed between the outlet of a filter rod making machine and the inlet of a filter tipping machine for the making of filter cigarettes or the like or the inlet of any other machine which is designed or intended to process filter mouthpieces of unit length or multiple unit length.

### OBJECTS OF THE INVENTION

An object of the present invention is to provide an apparatus which renders it possible to greatly reduce the space requirements of an assembly including a maker of filter rod sections and a machine for the processing of such products.

Another object of the invention is to provide an arrangement wherein the dimensions of the magazine for temporary storage of filter rod sections containing atomized softener for fibrous filter material for tobacco smoke can be reduced to a fraction of the dimensions of such magazines in standard arrangements.

A further object of the invention is to provide an apparatus which can greatly accelerate the setting of triacetin or another suitable softening agent for acetate fibers or the like.

An additional object of the instant invention is to provide a novel and improved heating system for filter rod sections which are being turned out by a filter rod making machine.

Still another object of the present invention is to provide a novel and improved space-saving combination of magazines for filter rod sections.

A further object of this invention is to provide a novel and improved method of treating filter mouthpieces for tobacco smoke between one or more makers of such products and one or more processing machines.

Another object of the invention is to provide a novel and improved machine or production line for the making of filter cigarettes and the like.

### SUMMARY OF THE INVENTION

One feature of the present invention resides in the provision of an apparatus for processing filter rod sections for tobacco smoke between at least one first machine which turns out filter rod sections and at least one second machine which processes such products. The improved apparatus comprises means for advancing a mass flow of filter rod sections along an elongated path extending from the at least one first machine toward the at least one second machine, and means for electromagnetically heating successive increments of the advancing mass flow in at least one portion of the path.

The apparatus further comprises a variable-capacity magazine for temporary storage of heated filter rod sections in a second portion of the path. The magazine can include or constitute a so-called surge bin or surge chamber, and the second portion of the path can be disposed between the at least one portion of the path and the at least one second machine. The magazine need not be large; for example, such magazine can be designed and dimensioned to define a storage facility for a portion (e.g., a relatively small portion) of the mass flow of filter rod sections in the path.

The at least one first machine is or can be designed and set up to turn out or discharge a single layer of filter rod sections which move sideways, and the advancing means of such apparatus preferably further comprises a tapering horn or other suitable means for converting the single layer into a mass flow of filter rod sections which move sideways.

In accordance with a presently preferred embodiment, the means for advancing the mass flow comprises at least one driven endless belt or band or chain conveyor (hereinafter called belt conveyor) which is arranged to transport the filter rod sections of the mass flow sideways, at least along the aforementioned at least one portion of the path. For example, the advancing means can comprise first and second endless belts which define, at least, the at least one portion of the path; one of the first and second belts is then located above and the other of these belts is located below the at least one portion of the path. Such advancing means further comprises an electric motor or other suitable means for driving the at least one belt or at least one of the first and second belts.

The heating means can comprise at least one microwave heater employing a plurality of modules; such modules can be assembled into several sets which define a passage for sidewise advancement of filter rod sections travelling in the at least one portion of their path. One or more modules is or can be adjustable and, if the at least one first machine is arranged to supply to the path filter rod sections at a variable rate, such apparatus can further comprise means for monitoring changes in the rate of delivery of filter rod sections by the at least one machine; still further, such apparatus can comprise means for adjusting the adjustable module or modules of the microwave heater(s) in dependency upon monitored changes of the rate of delivery of filter rod sections by the at least one first machine. The adjusting means can comprise at least one pulse generator and/or at least one selection generator as well as means for operatively connecting the selection generator and/or the pulse generator with the monitoring means.

In addition to or in lieu of the aforementioned monitoring means, the apparatus can comprise means for measuring the temperature of successive increments of the mass flow in the elongated path, and means for transmitting appropriate signals to the pulse generator and/or to the selection generator. The temperature measuring means can comprise a contact-free thermometer, i.e., a thermometer which does not or need not contact the constituents of the mass flow; such thermometer can be installed in the improved apparatus in such a way that it is adjacent the end faces of filter rod sections in successive increments of the mass flow in the path, i.e., at one side of such path.

Another feature of the present invention resides in the provision of a method of treating rod-shaped filter rod sections or mouthpieces for tobacco smoke. The method comprises the steps of advancing a mass flow of parallel mouthpieces sideways in a predetermined direction along a predetermined path, electromagnetically heating successive increments of the mass flow advancing along a first portion of the path, and temporarily storing heated increments of the mass flow in a second portion of the path downstream of the first portion.

If the mouthpieces contain acetate fibers and a heat-settable solvent (such as triacetin) for acetate fibers, the method can further comprise the steps of selecting the intensity of the heating step and the duration of temporary storage of heated mouthpieces in such a way that one ensures a setting of the solvent upon completion of the storing step.

The method can further comprise the steps of delivering filter mouthpieces into the path at a variable rate, and varying the heating step in dependency upon the rate of delivery of mouthpieces into the path.

It is also possible to make the intensity of the heating step dependent upon the temperature of successive increments of the mass flow of mouthpieces downstream of the locus of heating such increments of the mass flow.

The novel features which are considered as characteristic of the invention are set forth in particular in the appended claims. The improved apparatus itself, however, both as to its construction and the modes of assembling, installing and operating the same, together with numerous additional important and advantageous features and attributes thereof, will be best understood upon perusal of the following detailed description of certain presently preferred specific embodiments with reference to the accompanying drawing.

### BRIEF DESCRIPTION OF THE DRAWING

The single FIGURE is a fragmentary schematic partly elevational and partly vertical sectional view of an apparatus which is installed between a filter rod making and a filter tipping machine and is constructed an assembled in accordance with one presently preferred embodiment of the invention.

### DESCRIPTION OF PREFERRED EMBODIMENTS

The apparatus which is shown in the drawing is installed between a filter rod making (first) machine 2 and a filter tipping (second) machine 41. The machine 2 turns out a single layer of filter rod sections or mouthpieces 1 (e.g., mouthpieces of six times unit length) which are moved sideways in the axially parallel peripheral flutes 5 of a drum-shaped rotary conveyor 10. Such single layer of mouthpieces 1 is converted into a multiple-layer mass flow 7 during advancement through a fowardly tapering horn 6 wherein the mouthpieces advance sideways (arrow A) into an elongated horizontal path defined at least in part by an advancing unit including the aforementioned horn 6 and two endless conveyor belts 8 and 9. The lower reach or stretch of the belt 8 engages the topmost layer, and the upper reach or stretch of the belt 9 supports and advances the lowermost layer of the mass flow 7 of mouthpieces 1 on their way through a novel and improved heating unit 3 and toward and into a variable-capacity magazine 4; the latter is located between the heating unit 3 and the second machine 41.

The machine 2 can be of the type known as AF 3/KDF 3 or AF 3E/KDF 3E distributed by the assignee of the present application, and the machine 41 can be of the type known as MAX S, also distributed by the assignee of the present application. The mouthpieces 1 issuing from the machine 2 are assumed to contain rod-like fillers consisting of or containing acetate fibers which carry droplets of atomized softening agent (plasticizer) such as triacetin. The droplets soften the respective portions of the fibers, and such portions of neighboring fibers are bonded to each other by the softening agent when the latter sets. Setting of softening agent is promoted by heat during sidewise movements of the respective mouthpieces 1 through the microwave heating unit 3, and the setting is completed during dwell of freshly heated mouthpieces in the variable-capacity magazine 4. The converting horn 6 is adjacent to the conveyor 10 of the machine 2, and the advancing unit including the belts 8, 9 directs successive increments of the freshly heated mass flow 7 directly into the magazine 4. The latter can feed freshly dried filter rod sections or mouthpieces 1 directly into the inlet of the second machine 41.

The microwave heating unit 3 includes a heating chamber 11 traversed by that portion of the path for the mass flow 7 which is flanked by the straight horizontal stretches of the belts 8, 9. The chamber 11 has two groups or rows of tubular inlets 12 connected to the outlets of discrete adjustable microwave modules 13 of conventional design; these modules together form two horizontal or substantially horizontal sets or groups of modules, and such sets of modules define a horizontal passage for sidewise advancement of filter rod sections or mouthpieces 1 in that (horizontal) portion or section of the path which extends from the horn 6 to the inlet (at 27) of the magazine 4.

The modules 13 generate energy and flank the straight stretches of the belts 8 and 9; the energy penetrates through the straight stretches of the belts, and the rate of energy transmission or discharge by the modules 13 is regulatable by a pulse generator 14 having an input receiving signals via conductor 16 from a monitoring means 17 here shown as an RPM sensor arranged to transmit signals denoting the momentary RPM (i.e., changes of rotational speed) of the conveyor 10. This is indicative of the rate of delivery of a single layer of filter mouthpieces 1 from the machine 2 into the horn 6 of the means for forming and advancing the mass flow 7 in the direction of the arrow A. The connection between the pulse generator 14 and the adjacent set of modules 13 comprises discrete conductors 18. The signals being transmitted by the conductors 18 determine the activation phases or stages of the respective modules 13.

The pulse generator 14 can be operatively connected with all of the illustrated microwave modules 13. However, the illustrated heater 4 further comprises a contactless thermometer 23 which is adjacent but still spaced apart from one side of the mass flow 7 at the inlet of the magazine 4 and serves as a means for transmitting signals (via conductors 24, 26) to the pulse generator 14 as well as to a so-called selection generator 21. The generator 21 is connected with the adjacent set of modules 13 by way of conductors 22. An input of the selection generator 21 is further connected with an output of the RPM sensor 17 by way of a conductor 19.

The illustrated means for adjusting the modules 13 can be modified in a number of ways without departing from the spirit of the present invention. For example, all of the modules 13 can receive signals only from the RPM sensor 17 or only from the temperature measuring means (contactless thermometer) 23. Alternatively, some of the modules 13 can receive signals from the sensor 17 and/or from the thermometer 23, and the remaining modules can receive signals from the thermometer 23 and/or from the sensor 17. The number of modules 13 in both groups can but need not be the same, and the characteristics of all modules. too, may but need not be identical.

The purpose of the generator 21 is to selectively activate or deactivate some or all of the modules 13, i.e., to determine the intervals of activation and deactivation of modules which are operatively connected thereto.

The thermometer 23 preferably further serves as a means for deactivating some or all of the modules 13 (via generator 14 and/or 21) when the ascertained temperature of those increments of the mass flow 7 which advance past the thermometer rises to a predetermined maximum permissible value. Still further, the thermometer 23 can be set up to respond to a preselected maximum permissible temperature to simply turn off the entire microwave heater 3, e.g., for a preselected (preferably variable) interval of time.

It has been ascertained that, if the height of the mass flow 7 between the neighboring straight reaches of the belts 8, 9 is about 80 mm, and if the microwave heater 3 is set to heat the mass flow to a temperature of approximately 50° C., adequate hardening or setting of triacetin in the path between the machines 2 and 41 requires approximately two minutes; the mouthpieces 1 are then ready to be processed (e.g., assembled into filter cigarettes with plain cigarettes supplied by a cigarette rod maker such as the machine known as GARANT and distributed by the assignee of the present application) as soon as they enter the machine 41. In view of such shortness of the intervals which are required to complete the setting of the softening agent on its way from the locus of application of atomized plasticizer to the filaments of the mouthpieces 1 to the machine 41, the capacity of the magazine 41 can be a small fraction of the capacities of magazines in conventional apparatus which operate without an equivalent of the microwave heater 3.

The inlet for entry of successive increments of the mass flow 7 into the magazine 4 is disposed at a normally sealed and/or closed outlet 27 from the path for the mouthpieces 1. Such outlet is adjacent to pulleys 8a, 9a which form part of the means for driving the belts 8, 9, preferably at a speed which is synchronized with the RPM of the conveyor 10 in the machine 1.

Successive freshly heated increments of the mass flow 7 which enter the magazine 4 at 27 normally advance downwardly into a meandering portion or section 28 of the magazine 4; such meandering portion is defined in part by two superimposed horizontal belt conveyors 29, 31. The magazine 4 further comprises stationary walls some of which are shown at 32, 33, 34, 36 and 37. The outlet 39 of the magazine 4 includes a vertical or nearly vertical duct 37 which discharges parallel mouthpieces 1 into the inlet of the machine 41.

A sensor 42 at the outlet 27 monitors the rate at which the freshly heated increments of the mass flow 7 leave the path between the horizontal reaches of the belts 8, 9 and regulates the capacity of the actual variable buffer or surge bin 46 of the magazine 4. The capacity of the surge bin 46 is varied by moving an endless belt or band conveyor 43 the upper reach of which carries a stop 44 for the mouthpieces in the surge bin 46. The latter is a first-in last-out magazine or reservoir which accepts or discharges mouthpieces 1, depending upon the nature and/or intensity of signals being transmitted by the sensor 42. The rate of admission of freshly heated mouthpieces 1 into the actual surge bin 46 can fluctuate between zero and the entire throughput of the advancing means including the belts 8, 9 and the pulleys 8a, 9a, i.e., the rate of flow of mouthpieces 1 through the outlet 39 of the magazine 4 and into the machine 41 can vary between a maximum value (when the entire mass flow 7 advances from the path between the belts 8, 9 into the outlet 39) and zero (i.e., when the entire output of the conveyor system including the belts 8, 9 is directed into the surge bin 46). The sensor 42 can also cause the conveyor 43 and its stop 44 to expel mouthpieces 1 from the surge bin 46 into the meandering portion or section 28 of the magazine 4, i.e., into the path for advancement of mouthpieces toward and into the machine 41.

The meandering portion 28 can be designed to accept and temporarily confine discrete (heated) mouthpieces 1 for intervals of time in the range of two minutes or even a little longer. This ensures adequate hardening or setting of customary softeners (such as triacetin) when the temperature of freshly heated mouthpieces 1 advancing past the thermometer 23 is close to or equals 50° C. and when the rate of advancement of mouthpieces through the microwave heater 3 is in the range of approximately 6000 per minute. A storing of freshly heated mouthpieces 1 upstream of the machine 41 for periods of about 2 minutes or even for periods somewhat exceeding 2 minutes renders it possible to employ a surprisingly small magazine 4, i.e., to achieve substantial savings in space without affecting the quality of mouthpieces which enter the machine 41 in a condition ready for further processing, e.g., for conversion into portions of filter cigarettes. In fact, the dimensions of the magazine 4 can be reduced to such an extent that the magazine merely serves as a means for compensating for eventual fluctuations of the output of the machine 2 and/or of the requirements of the machine 41.

Another important advantage of the improved method and apparatus is that the constituents of the apparatus are readily accessible for inspection, adjustment, repair and/or replacement. This is attributable, at least to a certain extent, to the fact that the horn 6 is located directly at the outlet of the machine 2 as well as that the microwave heater 3, or an equivalent thereof, is installed directly between the horn 6 of the advancing means for the mouthpieces 1 and the surge bin 46 of the magazine 4. If the production line including the machines 2 and 41 is mounted and arranged in the customary way, the illustrated layout of the improved apparatus renders it possible to gain access to the parts of the heater 3 from the front side of the production line with little loss in time because the constituents of the improved apparatus take up a surprisingly small amount of space.

It has been ascertained that the radiation-permeable belts 8, 9 can constitute parts of a highly reliable, compact and relatively inexpensive mass flow advancing unit which renders it possible to heat the mouthpieces to a desired temperature (such as approximately 50° C. if the softening agent is triacetin which is sprayed onto a stretched tow of acetate fibers, e.g., in a manner as fully described in the aforementioned U.S. Pat. No. 4,412,505 to Häusler et al.) within surprisingly short and accurately selectable intervals of time.

The utilization of several groups or rows or arrays of adjustable modules renders it possible to ensure a highly predictable heating of the mouthpieces 1 in the mass flow 7, not only because the path which is defined by the straight stretches of the belts 8 and 9 extends through the heating chamber 11 but also because the modules 13 can be adjusted in dependency upon several variables such as the rate of delivery of mouthpieces by the machine 2 (see the sensor 17) and/or in dependency upon the actual temperature of freshly heated mouthpieces (see the thermometer 23).

The generator 21 can be controlled by signals received from the sensor 17 via conductor means 19 to vary (select) the number of active modules 13 in dependency upon variations of the output of the machine 2. This prevents an overheating of the contents of the mass flow 7 if the speed of such mass flow is reduced due to a reduction of the output of the machine 2. Analogous results can be obtained if the generator 14 and/or 21 is adjusted by signals which are being generated by the thermometer 23 and transmitted via conductor means 24 and/or 26.

An additional important advantage of the improved method and apparatus is that the inertia of the apparatus is reduced to a great extent, i.e., the apparatus is capable of reacting to changes in the output of the mouthpiece making machine 2 (or an equivalent thereof) and/or in the changes of requirements of the processing machine 41 within very short intervals of time. This is especially desirable when the requirements of the processing machine 41 are likely to fluctuate within a wide range.

Still further, it is now possible to ensure that the requirements of the processing machine 41 can be met practically immediately after this machine is started or after the requirements of the machine 41 are greatly increased or decreased without any or with a negligible interval of transition from lower-speed operation to operation at a much higher speed of vice versa.

It is also within the purview of the present invention to supply to the microwave heater 3 or to another suitable electromagnetic heater the output of two or even more machines 2 or analogous machines, and to utilize the magazine 4 or an equivalent magazine as a source of filter mouthpieces with dried softener for two or more machines 41 or analogous machines.

Without further analysis, the foregoing will so fully reveal the gist of the present invention that others can, by applying current knowledge, readily adapt it for various applications without omitting features that, from the standpoint of prior art, fairly constitute essential characteristics of the generic and specific apects of the above outlined contribution to the art of transporting and processing filter rod sections of the tobacco processing industry and, therefore, such adaptations should and are intended to be comprehended within the meaning and range of equivalence of the appended claims.

What is claimed is:

1. Apparatus for processing filter rod sections for tobacco smoke between at least one first machine which turns out filter rod sections and at least one second machine which processes filter rod sections, comprising:
means for advancing a mass flow of filter rod sections along an elongated path extending from the at least one first machine toward the at least one second machine; and
means for electromagnetically heating successive increments of the advancing mass flow in at least one portion of said path.

2. The apparatus of claim 1, further comprising a variable-capacity magazine for temporary storage of heated filter rod sections in a second portion of said path.

3. The apparatus of claim 2, wherein said magazine includes at least one surge bin.

4. The apparatus of claim 2, wherein said second portion of said path is disposed between said at least one portion of said path and the at least one second machine.

5. The apparatus of claim 2, wherein said magazine defines a storage facility for a portion of the mass flow of filter rod sections in said path.

6. The apparatus of claim 2 for processing filter rod sections issuing from at least one first machine which turns out a single layer of filter rod sections moving sideways, wherein said advancing means includes means for converting the single layer into the mass flow of filter rod sections moving sideways.

7. The apparatus of claim 2, wherein said advancing means comprises at least one driven endless belt conveyor arranged to transport the filter rod sections of the mass flow sideways at least along said at least one portion of said path.

8. The apparatus of claim 2, wherein said advancing means comprises first and second endless belts defining at least said at least one portion of said path, one of said belts being located above and the other of said belts being located below said at least one portion of said path.

9. The apparatus of claim 8, wherein said advancing means further comprises means for driving at least one of said belts.

10. The apparatus of claim 2, wherein said advancing means comprises means for advancing filter rod sections sideways, at least in said at least one portion of said path, said heating means including several sets of modules defining a passage for sidewise advancement of filter rod sections between said sets of modules in the at least one portion of said path.

11. The apparatus of claim 10, wherein at least one of said modules is adjustable and the at least one first machine is arranged to supply to said path filter rod sections at a variable rate, and further comprising means for monitoring changes in the rate of delivery of filter rod sections by the at least one first machine and means for adjusting said at least one module in dependency upon monitored chages of the rate of delivery of filter rod sections by the at least one first machine.

12. The apparatus of claim 11, wherein said adjusting means comprises at least one pulse generator.

13. The apparatus of claim 11, further comprising at least one selection generator for said at least one module and means for operatively connecting said selection generator with said monitoring means.

14. The apparatus of claim 13, further comprising signal generating means for measuring the temperature of successive increments of the mass flow in said path between said heating means and said magazine, and means for transmitting signals from said temperature measuring means to at least one of said pulse generator and said selection generator.

15. The apparatus of claim 14, wherein said temperature measuring means comprises a contact-free thermometer.

16. The apparatus of claim 15, wherein said thermometer is adjacent end faces of filter rod sections in successive increments of the mass flow in said path.

17. The apparatus of claim 11, further comprising signal generating means for measuring the temperature of successive increments of the mass flow in said path between said heating means and said magazine, and means for transmitting signals from said temperature measuring means to said pulse generator.

18. The apparatus of claim 17, wherein said temperature measuring means comprises a contact-free thermometer.

19. The apparatus of claim 18, wherein said thermometer is adjacent end faces of filter rod sections in successive increments of the mass flow in said path.

20. A method of treating rod-shaped filter mouthpieces for tobacco smoke, comprising the steps of:
advancing a mass flow of parallel mouthpieces sideways in a predetermined direction along a predetermined path;
electromagnetically heating successive increments of the mass flow advancing along a first portion of said path; and
temporarily storing heated increments of the mass flow in a second portion of said path downstream of said first portion.

21. The method of claim 20, wherein the mouthpieces contain acetate fibers and a heat-settable solvent for acetate fibers, and further comprising the steps of selecting the intensity of said heating step and the duration of temporary storage of heated mouthpieces with a view to ensure a setting of the solvent upon completion of said storing step.

22. The method of claim 20, further comprising the steps of delivering filter mouthpieces into said path at a variable rate and varying the heating step in dependency upon the rate of delivery of mouthpieces into said path.
